(19) United States
(12) Patent Application Publication
(10) Pub. No.: US 2025/0356269 A1
(43) Pub. Date: Nov. 20, 2025

(54) TRAVEL PLANNING USING DIGITAL ASSISTANT

(71) Applicant: priceline.com LLC, Norwalk, CT (US)

(72) Inventors: Jacobus Pieter Kok, Kingston, NY (US); Brookes Parker Stephens, East Orange, NJ (US); Chi Jin, Norwalk, CT (US)

(21) Appl. No.: 18/669,376

(22) Filed: May 20, 2024

(51) Int. Cl. G06Q 10/02; G06F 9/451; G06F 40/35

(52) U.S. Cl. CPC G06Q 10/02; G06F 9/453; G06F 40/35

(57) ABSTRACT

As disclosed herein, a computer-implemented method for travel planning is provided. The computer-implemented method may include receiving, via a conversational user interface (UI), a user input associated with a product offered by a booking application. The computer-implemented method may include retrieving, from a database associated with the booking application, at least one attribute of the product. The computer-implemented method may include determining, using a first machine learning (ML) model of a plurality of ML models, a user intent associated with the user input. The computer-implemented method may include generating, based on the at least one attribute and the user intent, a first response to the user input. The computer-implemented method may include providing, via the conversational UI, the first response to the user input. A system and a non-transitory computer-readable storage medium are also disclosed.

### BACKGROUND

### Field

The present disclosure generally relates to online travel planning. More particularly, the present disclosure relates to computer-implemented techniques for planning travel through an interactive conversational exchange.

### Related Art

Travel planning has undergone significant transformations with the advent of the Internet and digital technologies. Traditional brick-and-mortar travel agencies have gradually been supplanted by online travel agencies (OTAs), which offer users the convenience of researching, comparing, and booking travel products from the comfort of their own homes.

Existing OTAs typically provide users with access to a wide range of travel-related products, including lodgings, flights, cruises, car rentals, activities, and travel packages. These platforms aggregate data from multiple suppliers and service providers, presenting users with various options to suit their preferences, budgets, and travel needs. Furthermore, OTAs often incorporate additional features and functionalities to enhance the user experience, such as interactive search tools, filtering options, price alerts, itinerary management tools, and reviews and ratings. These features aim to streamline the travel planning process, empower users with relevant information and insights, and facilitate the booking of travel products.

### SUMMARY

The subject disclosure provides for systems and methods for assisting a user with travel planning. Via a conversational user interface (UI), a user may submit queries about a travel product. In response to the queries, the user may be provided with prompts that assist the user with researching or booking the travel product.

According to certain aspects of the present disclosure, a computer-implemented method for travel planning is provided. The computer-implemented method may include receiving, via a conversational user interface (UI), a user input associated with a product offered by a booking application. The computer-implemented method may include retrieving, from a database associated with the booking application, at least one attribute of the product. The computer-implemented method may include determining, using a first machine learning (ML) model of a plurality of ML models, a user intent associated with the user input. The computer-implemented method may include generating, based on the at least one attribute and the user intent, a first response to the user input. The computer-implemented method may include providing, via the conversational UI, the first response to the user input.

According to another aspect of the present disclosure, a system is provided. The system may include one or more processors. The system may include a memory storing instructions that, when executed by the one or more processors, cause the system to perform operations. The operations may include receiving, via a conversational user interface (UI), a user input associated with a product offered by a booking application. The operations may include retrieving, from a database associated with the booking application, at least one attribute of the product. The operations may include determining, using a first machine learning (ML) model of a plurality of ML models, a user intent associated with the user input. The operations may include generating, based on the at least one attribute and the user intent, a first response to the user input. The operations may include providing, via the conversational UI, the first response to the user input.

According to yet other aspects of the present disclosure, a non-transitory computer-readable storage medium storing instructions encoded thereon that, when executed by a processor, cause the processor to perform operations, is provided. The operations may include receiving, via a conversational user interface (UI), a user input associated with a product offered by a booking application. The user input may include a text input. The product may include at least one of a lodging, a means of transportation, and a destination activity. The booking application may include a travel booking application. The operations may include retrieving, from a database associated with the booking application, at least one attribute of the product. The operations may include selecting a first machine learning (ML) model of a plurality of ML models based on the at least one attribute of the product. The first ML model may include a large language model (LLM). The operations may include determining, using the first ML model, a user intent associated with the user input. The operations may include generating, based on the at least one attribute and the user intent, a first response to the user input. The operations may include determining the first response to the user input includes a marker indicating the user intent. The operations may include determining, based on the marker, a second response to the user input. The operations may include providing, via the conversational UI, the second response. The operations may include initiating, via the conversational UI, a booking of the product, wherein the user intent includes an intent to book the product.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an environment in which computerized systems, processes, and methods for planning travel through an interactive conversational exchange may operate or be used, according to some embodiments;

FIG. 2 is a block diagram illustrating details of at least one client device and at least one server that may be used in computerized systems, processes, and methods as disclosed herein, according to some embodiments;

FIGS. 3A and 3B include a flowchart illustrating a process for planning travel through an interactive conversational exchange, according to some embodiments;

FIGS. 4A and 4B include a flowchart illustrating a process for planning travel through an interactive conversational exchange, according to some embodiments;

FIGS. 5A-5E illustrate an example view of a booking application configured to include a conversational user interface (UI) for assisting a user with travel planning, according to some embodiments;

FIG. 6 is a flowchart illustrating operations in a method for planning travel through an interactive conversational exchange, according to some embodiments; and

FIG. 7 is a block diagram illustrating an exemplary computer system with which client devices, and the methods and processes in FIGS. 3A-3B, 4A-4B, and 6 may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

Travel planning has undergone significant transformations with the advent of the Internet and digital technologies. Traditional brick-and-mortar travel agencies have gradually been supplanted by online travel agencies (OTAs), which offer users the convenience of researching, comparing, and booking travel products from the comfort of their own homes.

Existing OTAs typically provide users with access to a wide range of travel-related products, including lodgings, flights, cruises, car rentals, activities, and travel packages. These platforms aggregate data from multiple suppliers and service providers, presenting users with various options to suit their preferences, budgets, and travel needs. Furthermore, OTAs often incorporate additional features and functionalities to enhance the user experience, such as interactive search tools, filtering options, price alerts, itinerary management tools, and reviews and ratings. These features aim to streamline the travel planning process, empower users with relevant information and insights, and facilitate the booking of travel products.

Despite the availability of numerous OTAs in the market, travel planning can still be a time-consuming and complex process in which users encounter challenges such as information overload, lack of personalization, complexity in navigating OTA platforms, and uncertainty regarding the reliability and trustworthiness of suppliers and service providers. Additionally, traditional OTAs may struggle to keep pace with evolving user preferences and technological advancements, thereby limiting their ability to deliver truly innovative and differentiated travel experiences.

In recent years, advancements in artificial intelligence (AI) technologies (e.g., generative AI technologies) have paved the way for innovative solutions to simplify and enhance the travel planning experience by understanding user queries (e.g., queries expressed in natural language) and providing relevant information and recommendations tailored to individual preferences and requirements.

As disclosed herein, novel systems and methods represent a significant advancement in the field of travel planning technology by providing for leveraging AI technologies (e.g., generative AI technologies) to deliver intelligent, personalized, and user-centric travel planning assistance via a conversational user interface (or “chatbot”) designed to simulate or mimic human conversation. By leveraging AI technologies and access to comprehensive knowledge bases, a travel planning system may understand user inputs, retrieve relevant information from diverse data sources, and generate tailored user prompts in real time, enabling users to complete travel research, reservations, and transactions efficiently and conveniently.

According to an exemplary embodiment, a user may interact with a travel planning system via a conversational user interface (UI). The user may provide a first input (e.g., question, request, command, constraint, description, preference, or the like) about a travel product. Based on the first input, the user may retrieve from a database (e.g., an internal database or an external database) an attribute of the travel product (e.g., hotel availability, flight schedule, car rental pricing, destination climate, user review, or the like). The system may analyze the first input and the attribute of the travel product to determine an intent of the user (e.g., an intent to obtain information about a travel product, an intent to compare a first travel product to a second travel product, or an intent to obtain a booking of a travel product). Based on the intent of the user, the system may generate a first prompt in response to the first input. The first prompt may include information about the travel product or may solicit from the user a second input, to which the system may generate a second prompt. This process may continue iteratively until the user is satisfied with the information provided by the system.

In some embodiments, a travel planning system may employ at least one artificial intelligence (AI) model (e.g., a machine learning (ML) model, such as a unimodal or a multimodal generative model). The at least one Al model may be configured to learn and understand user inputs and to generate user prompts based thereon to assist the user with travel planning (e.g., researching a travel product, comparing travel products, or obtaining, modifying, or canceling a booking of a travel product).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

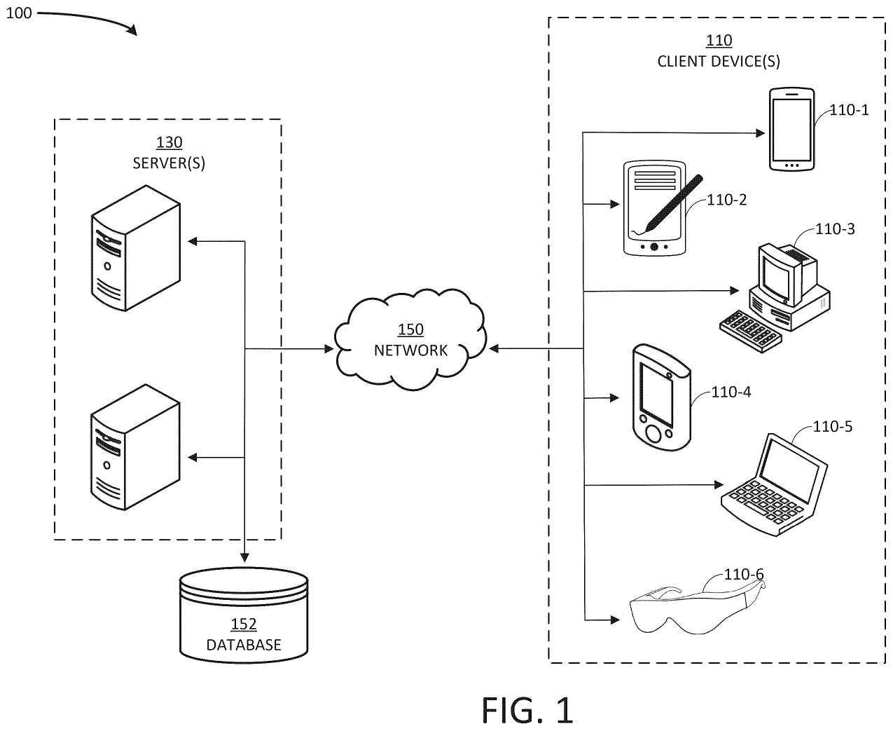

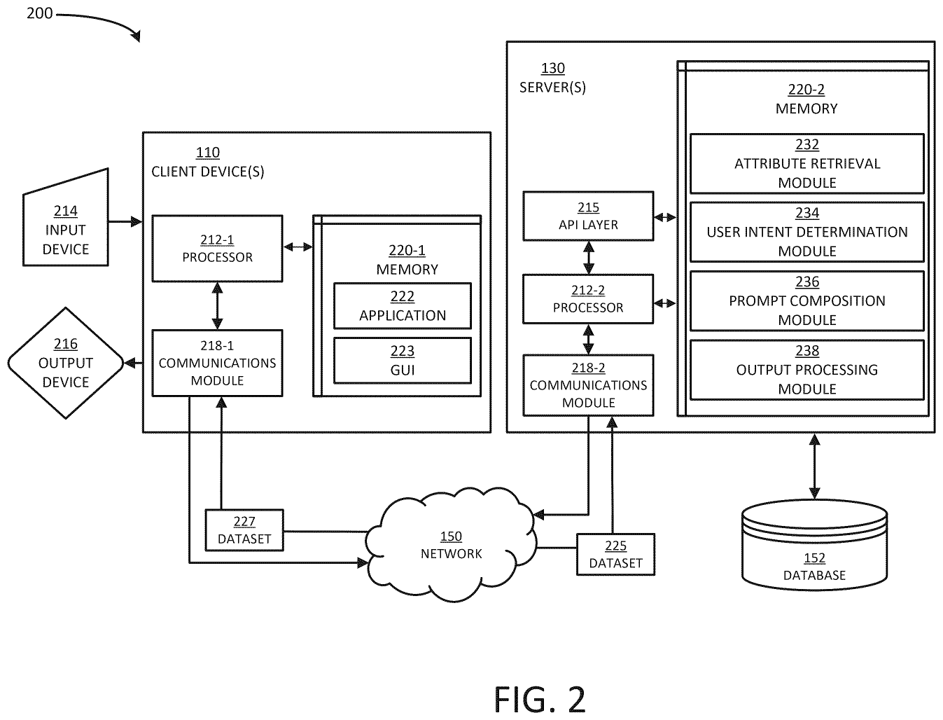

FIG. 1 illustrates an environment 100 in which computerized systems, processes, and methods for planning travel through an interactive conversational exchange may operate or be used, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing an attribute retrieval module (e.g., attribute retrieval module 232, FIG. 2), a user intent determination module (e.g., user intent determination module 234, FIG. 2), a prompt composition module (e.g., prompt composition module 236, FIG. 2), or an output processing module (e.g., output processing module 238, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and database 152 including multiple training archives for the attribute retrieval module, the user intent determination module, the prompt composition module, or the output processing module. Moreover, in some embodiments, multiple users of client device(s) 110 may access the same attribute retrieval module, user intent determination module, prompt composition module, or output processing module. In some embodiments, a single user with a single client device (e.g., one of client device(s) 110) may provide images and data (e.g., text) to train one or more machine learning models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for the attribute retrieval module, the user intent determination module, the prompt composition module, or the output processing module. Any of the attribute retrieval module, the user intent determination module, the prompt composition module, or the output processing module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., a virtual reality headset, augmented reality headset, or smart glass), such that at least one participant may be running an immersive reality application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating details of client device(s) 110 and server(s) 130 that may be used in computerized systems, processes, and methods as disclosed herein, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an AR/VR headset. For example, in some embodiments, input device 214 may include an eye-tracking device to detect the position of a pupil of a user in an AR/VR headset. Likewise, output device 216 may include a display and a speaker with which the customer may retrieve results from client device(s) 110. Client device(s) 110 may also include a processor 212-1, configured to execute instructions stored in a memory 220-1, and to cause client device(s) 110 to perform at least some of the steps in methods consistent with the present disclosure. Memory 220-1 may further include an application 222 and a graphical user interface (GUI) 223, configured to run in client device(s) 110 and couple with input device 214 and output device 216. Application 222 may be downloaded by the user from server(s) 130 and may be hosted by server(s) 130. In some embodiments, client device(s) 110 may be an AR/VR headset and application 222 may be an immersive reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a participant may upload, with client device(s) 110, dataset 225 onto server(s) 130, as part of a messaging interaction (or conversation, or “chat”). Accordingly, dataset 225 may include a message from the participant, or a multimedia file that the participant wants to share in a conversation.

A database 152 may store data and files associated with a conversation (or “chat”) from application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by a processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include attribute retrieval module 232, user intent determination module 234, prompt composition module 236, or output processing module 238. Attribute retrieval module 232, user intent determination module 234, prompt composition module 236, or output processing module 238 may share or provide features and resources to GUI 223. A user may access attribute retrieval module 232, user intent determination module 234, prompt composition module 236, or output processing module 238 through application 222, installed in a memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Attribute retrieval module 232 may be designed to determine, select, extract, parse, or analyze attributes of travel products from various internal or external sources (e.g., an internal or an external application, webpage, database, or server). Attribute retrieval module 232 may utilize multiple data retrieval mechanisms to access one or more relevant attributes of a travel product. By way of non-limiting example, the retrieval mechanisms may include application programming interfaces (APIs), Web scraping techniques, or data feeds provided by internal or external data sources. By interfacing with various data sources, attribute retrieval module 232 may ensure access to real-time and up-to-date information about travel products.

In some embodiments, attribute retrieval module 232 may, upon retrieving raw data from various sources, utilize NLP techniques to extract and parse relevant attributes from textual descriptions, reviews, specifications, and other data formats. NLP algorithms may analyze the textual content to identify key attributes such as pricing details, availability status, amenities, location information, user reviews, and booking policies. Attribute retrieval module 232 may structure and categorize the attributes into distinct categories based on their relevance and significance to a user input into a travel planning system. In some embodiments, a user input may be provided via a conversational user interface (UI). In further aspects, the conversational UI may include a text-based conversational UI (e.g., of a text messaging service, such as Short Message Service (SMS)), a speech-based conversational UI (e.g., of a telephone service), or a text- or speech-based conversational UI (e.g., of a website or an application). By way of non-limiting example, attribute categories may include cost-related attributes (e.g., prices, fees), location-based attributes (e.g., addresses, proximity to landmarks), amenity and facility attributes (e.g., room types, Wi-Fi availability), reviews and ratings, and booking terms and conditions.

In some embodiments, attribute retrieval module 232 may, after categorizing the attributes, integrate the structured attribute data into a unified format suitable for presentation via a conversational UI or suitable for inclusion in a prompt composed for a machine learning (ML) model (e.g., a unimodal or a multimodal generative model). The integration process may include standardizing attribute formats, resolving inconsistencies, and linking related attributes to provide a comprehensive overview of each travel product.

User intent determination module 234 may be designed to interpret or understand a user input, which may be in the form of text, voice, speech, audio, gesture, visual cue, or the like. User intent determination module 234 may analyze the semantic meaning and contextual nuances of user inputs. Leveraging ML models (e.g., unimodal or multimodal generative models), user intent determination module 234 may interpret user inputs to identify an intent and to extract relevant entities, parameters, and contexts associated with the user input.

In some embodiments, user intent determination module 234 may, once a user input is parsed and analyzed, categorize the user intent into predefined categories or domains relevant to travel planning. By way of non-limiting example, user intent categories may include flight booking, hotel reservation, destination exploration, activity planning, transportation inquiries, budget considerations, and itinerary management.

In some embodiments, in cases where a user input is ambiguous or unclear, user intent determination module 234 may employ disambiguation techniques to resolve ambiguities and clarify user intent. This may involve iterative interactions that include prompting a user for additional information, providing clarification prompts or suggestions, or dynamically adjusting the interpretation based on context and user feedback.

In some embodiments, user intent determination module 234 may incorporate machine learning (ML) algorithms to predict user intent based on historical data, user preferences, or behavioral patterns. By analyzing past interactions, user profiles, or contextual cues, user intent determination module 234 may anticipate user intentions and preferences, enabling proactive assistance and personalized recommendations. Additionally, user intent determination module 234 may continuously learn from user interactions to refine user intent determination capabilities and enhance the accuracy of future determinations.

In some embodiments, in scenarios where travel planning involves multi-turn conversations or complex interactions, user intent determination module 234 may manage the conversation flow to maintain context, coherence, and relevance throughout the interaction. User intent determination module 234 may track the progression of the conversation, store relevant information about the conversation (e.g., metadata), or dynamically adjust the conversation strategy based on user inputs and user prompts, which may ensure a seamless and natural dialogue experience, enabling a user to engage with a travel planning system in a fluid manner to accomplish travel planning goals.

Prompt composition module 236 may be designed to compose prompts for an ML model (e.g., a unimodal or a multimodal ML model). Prompt composition module 236 may leverage natural language processing (NLP) techniques, image recognition techniques, machine learning algorithms, or predefined templates to construct coherent and contextually relevant prompts that instruct the behavior of an ML model.

In some embodiments, based on a user intent and on contextual information associated with a user input (e.g., an attribute of a travel product), prompt composition module 236 may select an appropriate prompt template from a predefined library store in a database associated with prompt composition module 236. Prompt templates may be designed to encapsulate common tasks and interactions relevant to travel planning, including querying an ML model for information, generating responses, refining search criteria, and facilitating booking transactions.

In some embodiments, prompt composition module 236 may dynamically assemble one or more templates into coherent prompts tailored to a user intent and to contextual information associated with a user input. The assembly process may include parameter substitution, where placeholders within the templates may be replaced with extracted entities, parameters, and contextual information obtained from the user input. The assembly process may include parameter definition, where placeholders within the template may be left for an ML model receiving the prompts to populate with output data. By dynamically composing prompts, prompt composition module 236 may ensure that ML model outputs generated based on the prompts are personalized, relevant, and aligned with a user intent.

In some embodiments, prompt composition module 236 may incorporate contextual adaptation mechanisms to direct an ML model to adjust a tone, style, structure, content, or level of detail in an ML model output based on a user preference, a system policy (e.g., a policy of a travel planning system), a current stage of a conversation, or a historical understanding of a conversation. For example, ML model outputs generated for novice travelers may include more explanatory content and step-by-step guidance, and ML model outputs generated for experienced travelers may focus on providing concise, action-oriented directives. In another example, a system policy may direct an ML model to generate an output that includes no sensitive information (e.g., personally identifiable information (PII)) associated with a user or that includes no mention of third-party systems. In another example, an ML model prompt may include one or more markers (e.g., keywords, phrases, sentiments, text strings, tags, flags, or the like), and the ML model prompt may direct an ML model to determine which, if any, marker is associated with a user intent, and to include the marker in the ML model output based on determining the marker is associated with a user intent (e.g., a marker may indicate a user intent to book a flight, to compare hotel prices for different dates, to learn what museums are located near a destination, or the like). The markers may be used to determine which, if any, aspects of an ML model output to provide via a conversational UI. By way of non-limiting example, if the ML model output includes a marker (e.g., a how-to-book marker or a ready-to-book marker), then the ML model output may be modified to include a predefined user prompt (e.g., a booking instructions workflow or a checkout workflow) or may be replaced with the predefined user prompt.

Output processing module 238 may be designed to integrate various processing techniques, including post-generation analysis, context enrichment, content enrichment, quality assurance, and presentation optimization, to ensure an output satisfies a need or an expectation of a user.

In some embodiments, upon receiving an output from an ML model, output processing module 238 may conduct post-generation analysis to evaluate the quality, relevance, and coherence of the generated content. The post-generation analysis may include assessing factors such as grammatical correctness, semantic coherence, factual accuracy, and alignment with a user input and with a context associated with the user input (e.g., an attribute of a travel product). Outputs that do not meet predefined quality thresholds may be flagged for further processing or refinement.

In some embodiments, output processing module 238 may enhance the relevance and personalization of an output by enriching the content of the output with relevant parameters, entities, or contextual information obtained from the current user input, from previous conversation interactions, or from data (e.g., travel product attributes) retrieved from one or more data sources (e.g., internal or external databases or servers). By way of non-limiting example, relevant parameters, entities, or contextual information may include user preferences, location details, booking information, travel recommendations, or other data to tailor the output to the specific needs or preferences of a user.

In some embodiments, output processing module 238 may conduct quality assurance checks to ensure that an output meets established standards for accuracy, clarity, and user satisfaction. A quality assurance check may include verifying the information provided in the output against external data sources, cross-referencing with known facts, and conducting sanity checks to detect and correct any errors or inconsistencies in the output. In some embodiments, output processing module 238 may initiate a handoff to a live (human) agent (e.g., by initiating a live (human) agent workflow, or by providing contact information for a live (human) agent) if an output fails to meet established standards for accuracy, clarity, and user satisfaction.

In some embodiments, output processing module 238 may optimize the presentation of an output to enhance user comprehension and engagement. Optimizing the presentation of an output may involve formatting the output into structured summaries, incorporating multimedia elements (e.g., images, video, audio, animations), or providing interactive elements (e.g., buttons, links, quizzes, surveys, fillable forms). The presentation may be designed to be clear, concise, visually appealing, or easily digestible, maximizing the understanding and satisfaction of a user.

In some embodiments, in dynamic conversational contexts where user interactions evolve within a current conversation session or over multiple conversation sessions, output processing module 238 may adapt the presentation of outputs dynamically based on conversation context and user preferences. Adapting the presentation of outputs may include adjusting the tone, style, level of detail, or content structure of an output to maintain coherence, relevance, and continuity in a conversation. By adapting to the evolving context, output processing module 238 may ensure a seamless and engaging user experience throughout the travel planning process.

In some embodiments, output processing module 238 may integrate user feedback mechanisms to gather insights into user preferences, satisfaction levels, and areas for improvement. The feedback may be used to refine and optimize output processing strategies, enhance the quality of outputs, and improve overall user satisfaction. Through continuous monitoring, analysis, and refinement, output processing module 238 may deliver increasingly effective and user-centric outputs.

In some embodiments, output processing module 238 may detect a marker (e.g., keyword, phrase, sentiment, text string, tag, flag, or the like) included in an output, wherein the marker may be associated with a user intent (e.g., a marker may indicate a user intent to book a flight, to compare hotel prices for different dates, to learn what museums are located near a destination, or the like). Output processing module 238 may use the marker to determine which, if any, aspects of the output to provide via a conversational UI. By way of non-limiting example, if an output includes a ready-to-book marker or a request-for-human-agent marker, then output processing module 238 may modify the output to include a predefined user prompt (e.g., a checkout workflow or a live (human) agent workflow) or may replace the output with the predefined user prompt.

In some embodiments, a booking application (e.g., application 222) of a travel planning system (e.g., environment 100) may include an interface used for an automated travel planning process. All user inputs, system outputs, creative audio or visuals, and travel planning workflows (e.g., customer service workflow, product details workflow, booking details workflow, checkout workflow, post-booking workflow) may be provided via the interface. The interface may include a conversational UI (e.g., a text-based conversational UI or a speech-based conversational UI) by which the booking application may receive inputs from the user and may provide prompts to the user. A user may, via interactive elements of the conversational UI, restart a chat, provide feedback about the booking application, or complete a travel planning workflow. Travel planning workflows may include one or more interactive elements for collecting user input, providing a user with a rich, intuitive, and efficient means of completing common travel planning tasks (e.g., submitting payment information, finding a coupon code, connecting with a live (human) agent, emailing a travel itinerary, canceling a booking, taking a travel preferences quiz, watching or listening to an instructional recording). Travel planning workflows may be stored in an internal or an external database (e.g., database 152) associated with the travel planning system.

In further aspects, a travel planning system, via a conversational UI, may prompt a user to initiate a travel planning session (e.g., with a greeting or the like). For example, the conversational UI may provide as an initial user prompt, “Hi! I'm your travel planning assistant. How can I help you today?”

In further aspects, a booking application may be configured to receive an input (e.g., text, voice, speech, audio, gesture, visual cue, or the like) from a user. The user input may include a query, a description, or a preference related to a travel product offered by a travel planning system or related to a service associated with a travel planning system (e.g., a customer support service). By way of non-limiting example, a travel product may include a lodging (such as a hotel, resort, motel, hostel, guest house, holiday cottage, apartment, cabin, cruise ship, or bed and breakfast), a means of transportation (such as an airplane, car, train, cruise ship, or bicycle), a destination activity (such as a shoreside excursion, sporting event, or local tour), or an amenity associated with a lodging, means of transportation, or destination activity (such as a spa, fitness class, food service, or laundry service of a hotel). The user input may be solicited or unsolicited by the travel planning system. By way of non-limiting example, a solicited input may include an input related to a user prompt provided by the travel planning system (e.g., following a user prompt asking, “Would you like to continue booking the cruise?” a user input may include, “Not yet, tell me more about the cruise amenities”). By way of non-limiting example, an unsolicited input may include an input unrelated to a user prompt provided by the travel planning system (e.g., following a user prompt asking, “Would you like to continue booking the cruise?”, a user input may include, “What is the confirmation number for my car rental from last week?”). The user input may take many semantic and grammatical forms. By way of non-limiting example, a user input may include a text or speech request for “overnight flights from New York to Los Angeles.” Other examples of text or speech input may include the following: “Show me shore excursion options for the cruise,” or “Is the hotel well reviewed by customers?” Using an ML model, an output may be generated based on the user input.

In some embodiments, a conversation (or session) may continue until a user indicates (e.g., by text input, such as, “That's all the information I need for now,” or by the completion of a travel planning workflow, such as a checkout workflow) that the user requests no further information from the system or the user is satisfied with the information provided by the system. In some embodiments, a conversation may continue until the conversation session times out (e.g., due to inactivity) or until a user ends the conversation (e.g., by closing an appropriate window when a conversational UI mode is a website, or by hanging up a telephone when a conversational UI mode is a telephone call).

In some embodiments, when an initial user input (e.g., user input 570-1) is received, a conversation identification (ID) may be created. The initial user input and all subsequent user inputs and user prompts may be assigned to the conversation ID, creating a history of the conversation. A conversation history may be updated with each subsequent user input or user prompt. In some embodiments, a conversation history may be included in each ML model prompt, enabling the conversation history to inform the output generated by the ML model. In some embodiments, a conversation history may be included in each ML model output, enabling the conversation history to inform a user prompt determined or generated by a system (e.g., environment 100). In some embodiments, a conversation history may be stored (e.g., in an internal or an external database, such as database 152). Part or all of the conversation history may be accessed or retrieved from the storage location to be included in an ML model prompt, enabling the conversation history to inform the output generated by the ML model. In some embodiments, part or all of the conversation history may be accessed or retrieved from the storage location to inform a determining or a generating of a user prompt. In some embodiments, only a current or a most recent user input may be included in an ML model prompt, and in some embodiments, only a current or a most recent user input may be included in an ML model output.

In some embodiments, conversation histories may be stored (e.g., in an internal or an external database) for backend review to ensure that an ML model output meets established standards for accuracy, clarity, and user satisfaction. For instance, human reviewers or administrators may manually review a conversation history. Human reviewers may flag ML model outputs that do not meet predefined quality thresholds (e.g., hallucinations). In some embodiments, one or more trained ML models and/or neural networks may be used, either alone or in conjunction with human reviewers, to flag ML model outputs that do not meet predefined quality thresholds. For example, the machine learning model(s) and/or neural network(s) may be trained using datasets that include previously flagged conversation histories.

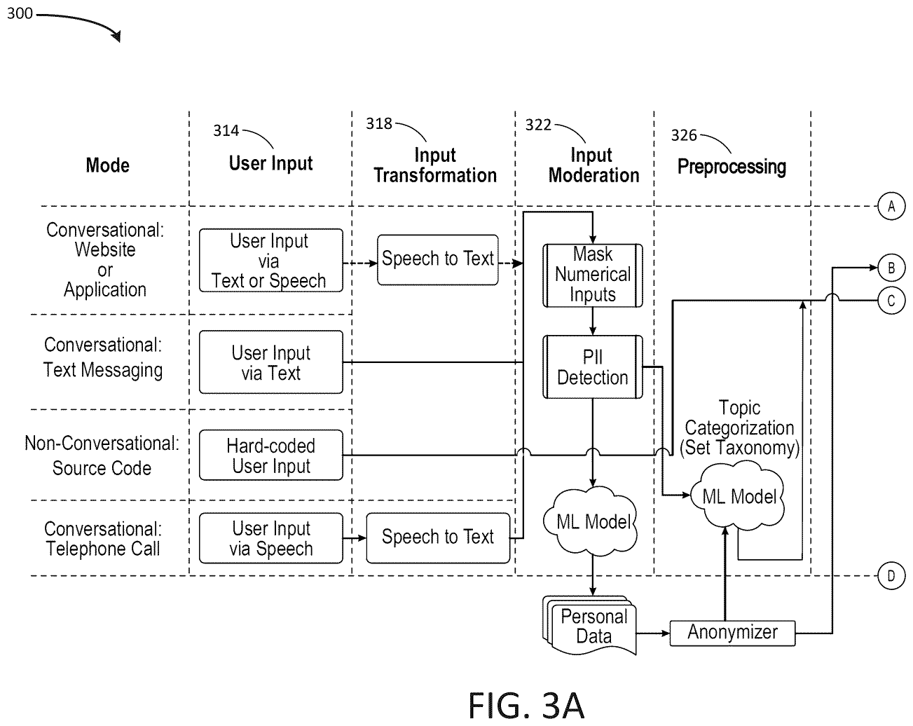

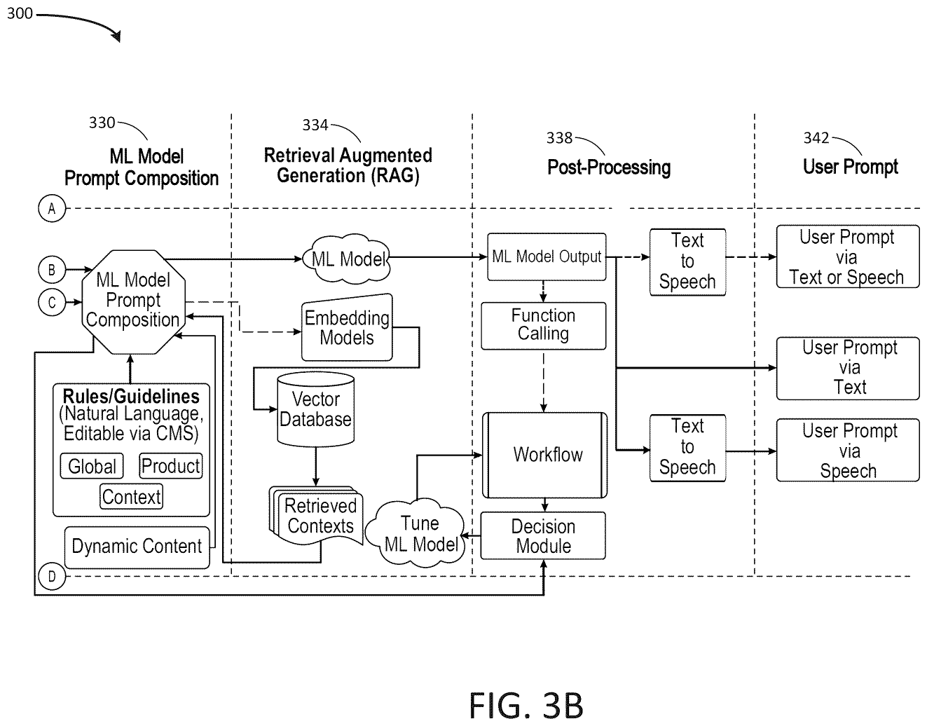

FIGS. 3A and 3B include a flowchart illustrating a process 300 for planning travel through an interactive conversational exchange, according to some embodiments. In some embodiments, processes as disclosed herein may include one or more operations in process 300 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in process 300 may be performed by an attribute retrieval module, a user intent determination module, a prompt composition module, or an output processing module (e.g., attribute retrieval module 232, user intent determination module 234, prompt composition module 236, or output processing module 238). In some embodiments, processes consistent with the present disclosure may include at least one or more operations as in process 300 performed in a different order, simultaneously, quasi-simultaneously, or overlapping in time.

At operation 314, a user input may be provided via a conversational mode or a non-conversational mode. A conversational mode may include a website or an application, and a user input associated with the website or application may include a text or a speech input. A conversational mode may include text messaging, and a user input associated with the text messaging may include a text input. A conversational mode may include a telephone call, and a user input associated with the telephone call may include a speech input. A non-conversational mode may include a source code of a program or other executable object, and a user input associated with the source code may include data directly embedded (“hard-coded”) into the source code. An initial or a follow-up prompt composed for an ML model may include a hard-coded user input. The ML model may be instructed to output a hard-coded user prompt or a generated user prompt (e.g., “Hi! I'm your travel planning assistant. How can I help you today?”) based on the hard-coded user input. In some embodiments, a hard-coded user input may be generated when a user accesses a conversational UI (e.g., by opening a website window or by initiating a phone call). At operation 318, a speech input may be transformed into a text input. For example, a speech input provided via a phone call or via an application may be transformed from speech to text using AI technologies (e.g., speech recognition models).

At operation 322, user inputs may be moderated to redact (e.g., obscure or remove) sensitive information. Numerical inputs (e.g., a phone number, a passport number, a driver's license number, or other unique identifier) included in a user input may be detected and masked. Personally identifiable information (PII) (e.g., full name, home address, email address, account number, IP address) included in a user input may be detected. If PII is detected or flagged, the user input, or a portion thereof (e.g., a PII portion), may be passed to a machine learning (ML) model (e.g., a large language model (LLM)) trained to identify and anonymize the PII.

At operation 326, if PII is not detected in a user input, then the user input, or a portion thereof, may be provided to an ML model for preprocessing. In some embodiments, if PII is detected in a user input, then the anonymized user input, or an anonymized portion of the user input (e.g., a PII portion), may be provided to an ML model for preprocessing. In some embodiments, operation 326 may include recombining a non-anonymized portion of a user input with an anonymized portion of a user input. Preprocessing may include categorizing a user input by topic or subtopic according to a taxonomy defined by a system a system (e.g., a system performing process 300). By way of nonlimiting example, a user input asking, “Are pets allowed at the rental property?” may be assigned main topic “amenities” and subtopic “pets.” The categories may be added to the user input as metadata. In some embodiments, operation 326 may include conducting a sentiment analysis on the user input to determine an emotional tone of the user input (e.g., a positive, negative, or neutral tone of the user input), and a sentiment determined at operation 326 may be added to the user input as metadata. In some embodiments, operation 326 may include adding a flag (e.g., a yes-no flag) to the user input as metadata, the flag indicating whether a current user input addresses or answers the last user prompt.

At operation 330, an ML model prompt may be composed. The ML model prompt may include user input, dynamic content, rules/guidelines, or retrieved contexts. The dynamic content may include one or more relevant attributes of a travel product associated with the user input. An attribute may be retrieved from various internal or external sources (e.g., an internal or an external database or server associated with a system performing process 300). The rules/guidelines may include a policy governing a required structure, format, or content of an output generated by an ML model. By way of non-limiting example, a structure may include one or more markers (e.g., keywords, phrases, sentiments, text strings, tags, flags, or the like) that the ML model should include in the output if the ML model determines a marker is associated with a user intent (e.g., an apply-coupon marker may be associated with a user intent to add a coupon to an online shopping cart). By way of non-limiting example, a format may include a file format, such as JavaScript Object Notation (JSON), Extensible Markup Language (XML), or HyperText Markup Language (HTML). By way of non-limiting example, a content may include only information associated with a system (e.g., a system performing process 300), and a content may exclude information associated with a competitor of the system. A rule/guideline may be provided to an ML model in natural language, and the rule/guideline may be editable via a content management system (CMS) associated with the system. A rule/guideline may be categorized as a global rule/guideline, a product-related rule/guideline, or a context-related rule/guideline. By way of non-limiting example, a global rule/guideline may include the following: “Provide short, accurate, easy-to-understand answers.” “Do not share any hyperlinks or links to images.” Or, “After every user input, inform the user they are welcome to ask additional questions.” By way of non-limiting example, a product-related rule/guideline may include the following: “Only answer questions about the hotel, current booking, or restaurants and sites close to the hotel.” By way of non-limiting example, a context-related rule/guideline may include the following: “If you are not able to update hotel booking dates, then search for a different hotel, add nights, or change the number of rooms.”

In some embodiments, rules/guidelines may include instructions for an ML model to include metadata in an ML model output. An ML model may be instructed to determine a language of a user input (e.g., Chinese, English, Spanish, Arabic, Hindi) and to add the language to an ML model output as metadata. An ML model may be instructed to categorize a user input by topic or subtopic. By way of nonlimiting example, a user input stating, “Tell me the mildest time of year to travel to the Bahamas,” may be assigned main topic “Bahamas” and subtopic “weather,” and the categories may be added to the ML model output as metadata. An ML model may be instructed to conduct a sentiment analysis on the user input to determine an emotional tone of the user input (e.g., a positive, negative, or neutral tone of the user input), and the sentiment may be added to the user input as metadata. An ML model may be instructed to add a flag (e.g., a yes-no flag) to the user input as metadata, the flag indicating whether a current user input addresses or answers the last user prompt. Metadata may be extracted from an ML model output and stored for further analysis. Metadata may be excluded from a user prompt.

In some embodiments, at operation 334, retrieval augmented generation (RAG) may be utilized to retrieve contextually relevant data (e.g., up-to-date, proprietary, private, or dynamic data) from a database associated with a system (e.g., a system performing process 300). The contextually relevant data may be provided to an ML model to improve the accuracy and performance of the ML model. System-specific data or proprietary data may be converted into vectors by providing the data as input into an embedding model, which may be a type of ML model that converts data into vectors, arrays, or groups of numbers. Vector representation of the data may enable the search for semantically similar items based on the numerical representation of the data. The vectors may be stored in a vector database. A semantic search of the vector database (e.g., a nearest neighbor search (NNS)) may be conducted to retrieve relevant and timely context that an ML model may use to produce more accurate outputs. By means of non-limiting example, when a user inputs a query in natural language, natural language search terms of the input may be translated into embeddings. The embeddings may be sent to a vector database, where a semantic search may be performed to determine vectors that most closely resemble a user intent. The results of the search (e.g., the retrieved contexts) may be included in a prompt composed for an ML model. The ML model may produce a more satisfactory (e.g., accurate or relevant) output because the ML model has access to the most contextually relevant data from the vector database.

At operation 338, an ML model output may be processed. Based on the ML model output, a user prompt may be determined or generated. The user prompt may include all aspects, no aspects, or some aspects of the ML model output. Output processing may include determining whether the ML model that generated the output included a marker (e.g., keyword, phrase, sentiment, text string, tag, flag, or the like) in the output, wherein the ML model may include the marker based on the ML model determining the marker is associated with a user intent (e.g., a marker may indicate a user intent to book a flight, to compare hotel prices for different dates, to learn what museums are located near a destination, or the like). A marker may be used to determine which, if any, aspects of the output to provide to a user. By way of non-limiting example, if the output includes a marker (e.g., a ready-to-book marker), then the output may be modified to include a predefined user prompt (e.g., a booking workflow) or may be replaced with the predefined user prompt. The determination (or decision) of which, if any, aspects of an ML model output to include in a user prompt may be used to tune the ML model that was used to generate the ML model output.

In some embodiments, operation 338 may include initiating a function call. An ML model may enable access to external application programming interfaces (APIs) by determining when and how a function should be called based on the context of an ML model prompt, and by structuring outputs based on a function specified in the ML model prompt. By way of non-limiting example, an ML model prompt may include a signature and a parameter of a weather function, and the ML model prompt may include a weather-related user input. The ML model may determine, based on the user input, a user intent to ask what the weather will be at a travel destination. In response to determining the user intent, the ML model may generate an output that includes an object (e.g., a JSON object) containing the weather function and arguments for calling the weather function. Operation 338 may include determining whether to call a function (e.g., a weather function) using function arguments provided by an ML model. Operation 338 may include calling a function (e.g., a weather function) using function arguments provided by an ML model, and receiving returned data from the function. Operation 338 may include determining which, if any, aspect of returned data to provide to a user. By way of non-limiting example, operation 338 may include modifying the ML model output to include returned data or may include replacing the ML model output with returned data. In further aspects, determining to provide an aspect of the returned data to a user may include initiating a predefined travel planning workflow and may include populating the travel planning workflow with the returned data. The travel planning workflow may be provided to a user via a conversational UI. The travel planning workflow may replace the ML model output or may include an aspect of the ML model output. The determination (or decision) of which, if any, aspects of returned data to include in a user prompt may be used to tune the ML model that was used to generate the ML model output.

At operation 338, a user prompt may be moderated to ensure a content, tone, structure, coherence, relevance, usefulness, appearance, or the like, of the user prompt is appropriate, is accurate, or abides by a guideline of a system (e.g., a system performing process 300). By way of non-limiting example, a content of a user prompt may be determined to be appropriate if the content includes no offensive language, such as profanity or threats, or no restricted words or phrases, such as names of competitor systems or competitor products. By way of non-limiting example, a content of a user prompt may be determined to be accurate if the content may be verified by fact-checking the content against information retrieved from a trusted source (e.g., a trusted internal or external database). A content of a user prompt may be determined to abide by a guideline of a system (e.g., a system performing process 300) if the content includes no personally identifiable information (PII). If an aspect of a user prompt (e.g., a content, a tone, a structure, a coherence, a relevance, a usefulness, an appearance, or the like) is determined to be inappropriate, to be inaccurate, or to violate a guideline of the system (e.g., a system performing process 300), then the user prompt may be rephrased to resolve the inappropriateness, the inaccuracy, or the violation, or the user prompt may be replaced with an alternative user prompt.

At operation 338, a text-based user prompt may be transformed into a speech-based user prompt, the text-based user prompt having been determined or generated according to an ML model output. In some embodiments, a determined or generated user prompt may include at least one of text, voice, speech, audio, gesture, visual cue, and the like. In further aspects, an ML model output (e.g., a text-based ML model output) may be transformed to include at least one of text, voice, speech, audio, gesture, visual cue, and the like using AI techniques (e.g., unimodal or multimodal generative models).

At operation 342, a user prompt may be provided to a user via text (example mode: text messaging), speech (example mode: telephone call), or at least one of text and speech (example mode: website or application).

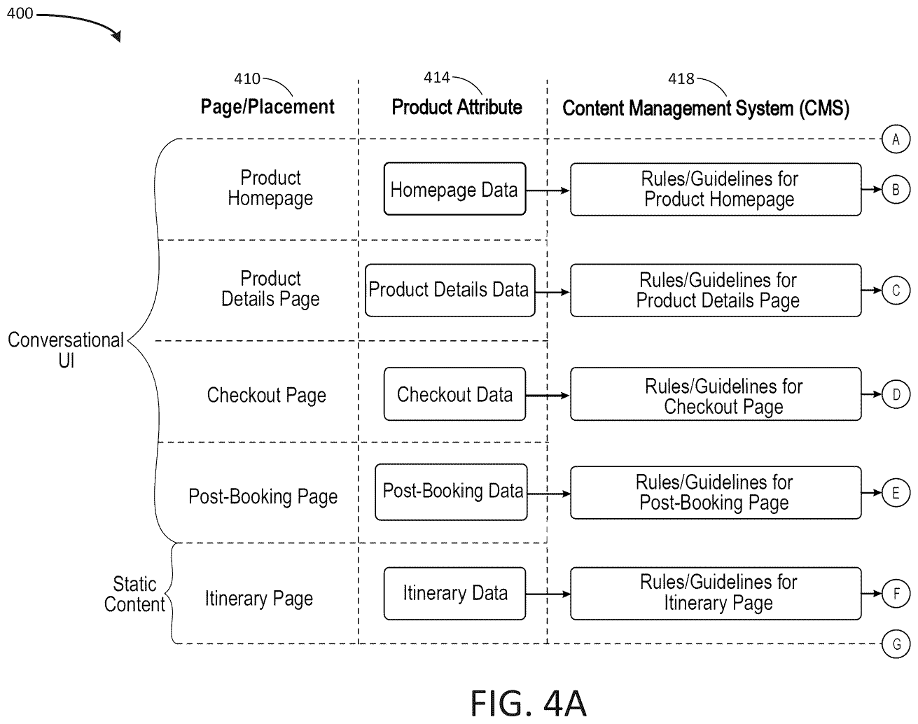

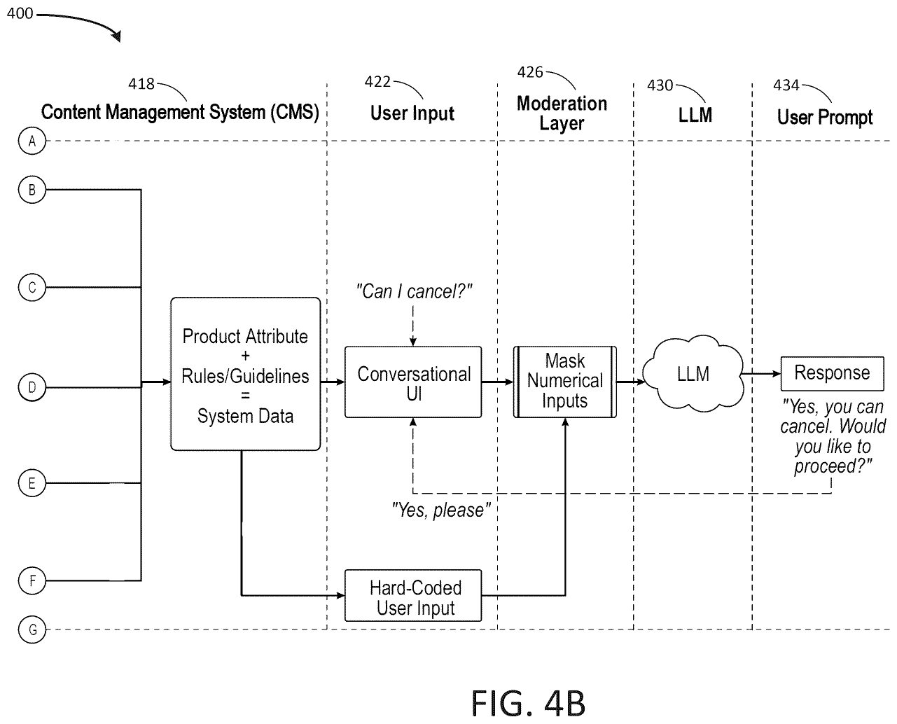

FIGS. 4A and 4B include a flowchart illustrating a process 400 for planning travel through an interactive conversational exchange, according to some embodiments. In some embodiments, processes as disclosed herein may include one or more operations in process 400 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in process 400 may be performed by an attribute retrieval module, a user intent determination module, a prompt composition module, or an output processing module (e.g., attribute retrieval module 232, user intent determination module 234, prompt composition module 236, or output processing module 238). In some embodiments, processes consistent with the present disclosure may include at least one or more operations as in process 400 performed in a different order, simultaneously, quasi-simultaneously, or overlapping in time.

At operation 410, a conversational UI may be included in or accessed via a page of an application (e.g., booking application 510) or website. The application or website may be associated with a travel planning system. At operation 414, a product attribute (e.g., a travel product attribute) may be retrieved from a data source (e.g., an internal or an external database or server). In some embodiments, a data source may include a page of an application or website. The application or website may be associated with a travel planning system. The page may include a product homepage, a product details page, a checkout page, a post-booking page, or an itinerary page.

At operation 418, a content management system (CMS) may associate a product attribute with rules/guidelines based on the source of the product attribute data. A product attribute retrieved from a product homepage (e.g., a general description of a hotel) may be associated with rules/guidelines for a product homepage. A product attribute retrieved from a product details page (e.g., a list of dining options offered by a hotel) may be associated with rules/guidelines for a product details page. A product attribute retrieved from a checkout page (e.g., a list of payment options) may be associated with rules/guidelines for a checkout page. A product attribute retrieved from a post-booking page (e.g., a confirmation of a successful booking) may be associated with rules/guidelines for a post-booking page. A product attribute retrieved from an itinerary page (e.g., a date associated with a booked hotel stay) may be associated with rules/guidelines for an itinerary page. A rule/guideline may include a policy governing a required structure, format, or content of an output generated by an ML model (e.g., unimodal or multimodal generative model). By way of non-limiting example, a structure may include one or more markers (e.g., keywords, phrases, sentiments, text strings, tags, flags, or the like) that the ML model should include in the output if the ML model determines a marker is associated with a user intent (e.g., an apply-coupon marker may be associated with a user intent to add a coupon for a purchase). By way of non-limiting example, a format may include a file format, such as JavaScript Object Notation (JSON), Extensible Markup Language (XML), or HyperText Markup Language (HTML). By way of non-limiting example, a content may include only information associated with a system (e.g., a system performing process 400) or only data retrieved from a page including a product attribute, and a content may exclude information associated with a competitor of the system. A rule/guideline may be provided to an ML model in natural language, and the rule/guideline may be editable via the CMS. A rule/guideline may be categorized as a global rule/guideline, a product-related rule/guideline, or a context-related rule/guideline. By way of non-limiting example, a global rule/guideline may include the following: “Provide short, accurate, easy-to-understand answers.” “Do not share any hyperlinks or links to images.” Or, “After every user input, inform the user they are welcome to ask additional questions.” By way of non-limiting example, a product-related rule/guideline may include the following: “Only answer questions about the hotel, current booking, or restaurants and sites close to the hotel.” By way of non-limiting example, a context-related rule/guideline may include the following: “If you are not able to update hotel booking dates, then search for a different hotel, add nights, or change the number of rooms.” At operation 418, one or more product attributes associated with one or more rules/guidelines may be included in system data.

In some embodiments, rules/guidelines may include instructions for an LLM to include metadata in an LLM output. An LLM may be instructed to determine a language of a user input (e.g., Chinese, English, Spanish, Arabic, Hindi) and to add the language to an LLM output as metadata. An LLM may be instructed to categorize a user input by topic or subtopic. By way of nonlimiting example, a user input stating, “Tell me the mildest time of year to travel to the Bahamas,” may be assigned main topic “Bahamas” and subtopic “weather,” and the categories may be added to the LLM output as metadata. An LLM may be instructed to conduct a sentiment analysis on the user input to determine an emotional tone of the user input (e.g., a positive, negative, or neutral tone of the user input), and the sentiment may be added to the user input as metadata. An LLM may be instructed to add a flag (e.g., a yes-no flag) to the user input as metadata, the flag indicating whether a current user input addresses or answers the last user prompt. Metadata may be extracted from an LLM output and stored for further analysis. Metadata may be excluded from a user prompt.

At operation 422, a user input (e.g., “Can I cancel?” or “Yes, please”) may be provided via a conversational UI. In some embodiments, a user input may include text, voice, speech, audio, gesture, visual cue, or the like. In some embodiments, a user input may include a query, a description, or a preference related to a travel product offered by a travel planning system or related to a service associated with a travel planning system (e.g., a customer support service). By way of non-limiting example, a travel product may include a lodging (such as a hotel, resort, motel, hostel, guest house, holiday cottage, apartment, cabin, cruise ship, or bed and breakfast), a means of transportation (such as an airplane, car, train, cruise ship, or bicycle), a destination activity (such as a shoreside excursion, sporting event, or local tour), or an amenity associated with a lodging, means of transportation, or destination activity (such as a spa or laundry service of a hotel). A user input may be solicited or unsolicited by the travel planning system. By way of non-limiting example, a solicited input may include an input related to a user prompt provided by the travel planning system (e.g., following a user prompt asking, “Would you like to continue booking the cruise?” a user input may include, “Not yet, tell me more about the cruise amenities”). By way of non-limiting example, an unsolicited input may include an input unrelated to a user prompt provided by the travel planning system (e.g., following a user prompt asking, “Would you like to continue booking the cruise?”, a user input may include, “What is the confirmation number for my car rental from last week?”). The user input may take many semantic and grammatical forms. By way of non-limiting example, a user input may include a text or speech request for “overnight flights from New York to Los Angeles.” Other examples of text or speech input may include the following: “Show me shore excursion options for the cruise,” or “Is the hotel well reviewed by customers?” In some embodiments, a conversational UI may include a text-based conversational UI (e.g., of a text messaging service, such as Short Message Service (SMS)), a speech-based conversational UI (e.g., of a telephone service), or a text- or speech-based conversational UI (e.g., of a website or an application). In some embodiments, a speech input may be transformed into a text input. For example, a speech input provided via a phone call or via an application may be transformed from speech to text using AI technologies (e.g., speech recognition models).

In some embodiments of operation 422, system data may include a hard-coded user input. The LLM may be instructed to output a hard-coded user prompt or a generated user prompt (e.g., “Hi! I'm your travel planning assistant. How can I help you today?”) based on the hard-coded user input. In some embodiments, a hard-coded user input may be generated when a user accesses a page or window (e.g., of a website or application), or initiates a phone call.

At operation 426, a user input, including a hard-coded user input, may be moderated to redact (e.g., obscure or remove) sensitive information. Numerical inputs (e.g., a phone number, a passport number, a driver's license number, or other unique identifier) included in a user input may be detected and masked. In some embodiments, personally identifiable information (PII) (e.g., full name, home address, email address, account number, IP address) included in a user input may be detected. If PII is detected or flagged, the user input, or a portion thereof (e.g., a PII portion), may be passed to a large language model (LLM) trained to identify and anonymize the PII.

In some embodiments, if PII is not detected in a user input, then the user input, or a portion thereof, may be provided to an LLM for preprocessing. In some embodiments, if PII is detected in a user input, then the anonymized user input, or an anonymized portion of the user input (e.g., a PII portion) may be provided to an LLM for preprocessing. In some embodiments, operation 426 may include recombining a non-anonymized portion of a user input with an anonymized portion of a user input. Preprocessing may include categorizing a user input by topic or subtopic according to a taxonomy defined by a system (e.g., a system performing process 400). By way of nonlimiting example, a user input asking, “Are pets allowed at the rental property?” may be assigned main topic “amenities” and subtopic “pets.” The categories may be added to the user input as metadata. In some embodiments, operation 426 may include conducting a sentiment analysis on the user input to determine an emotional tone of the user input (e.g., a positive, negative, or neutral tone of the user input), and a sentiment determined at operation 426 may be added to the user input as metadata. In some embodiments, operation 426 may include adding a flag (e.g., a yes-no flag) to the user input as metadata, the flag indicating whether a current user input addresses or answers the last user prompt.

At operation 430, an LLM prompt may be composed, and the LLM prompt may be provided to an LLM. The LLM prompt may include user input, dynamic content, rules/guidelines, or retrieved contexts. The dynamic content may include one or more relevant attributes of a travel product associated with the user input.

In some embodiments, retrieval augmented generation (RAG) may be utilized to retrieve contextually relevant data (e.g., up-to-date, proprietary, private, or dynamic data) from a database associated with a system (e.g., a system performing process 400). The contextually relevant data may be provided to an LLM to improve the accuracy and performance of the LLM. System-specific data or proprietary data may be converted into vectors by providing the data as input into an embedding model, which may be a type of ML model that converts data into vectors, arrays, or groups of numbers. Vector representation of the data may enable the search for semantically similar items based on the numerical representation of the data. The vectors may be stored in a vector database. A semantic search of the vector database (e.g., a nearest neighbor search (NNS)) may be conducted to retrieve relevant and timely context that an LLM may use to produce more accurate outputs. By means of non-limiting example, when a user inputs a query in natural language, natural language search terms of the input may be translated into embeddings. The embeddings may be sent to a vector database, where a semantic search may be performed to determine vectors that most closely resemble a user intent. The results of the search (e.g., the retrieved contexts) may be included in a prompt composed for an LLM. The LLM may produce a more satisfactory (e.g., accurate or relevant) output because the LLM has access to the most contextually relevant data from the vector database.

At operation 434, an LLM output may be processed, a user prompt may be determined or generated based on the LLM output, and the user prompt may be provided to a user via a conversational UI. A user prompt (e.g., “Yes, you can cancel. Would you like to proceed?”) may include all aspects, no aspects, or some aspects of the LLM output. Output processing may include determining whether the LLM that generated the output included a marker (e.g., keyword, phrase, sentiment, text string, tag, flag, or the like) in the output, wherein the LLM may include the marker based on the LLM determining the marker is associated with a user intent (e.g., a marker may indicate a user intent to book a flight, to compare hotel prices for different dates, to learn what museums are located near a destination, or the like). A marker may be used to determine which, if any, aspects of the output to provide to a user. By way of non-limiting example, if the output includes a marker (e.g., a ready-to-book marker), then the output may be modified to include a predefined user prompt (e.g., a booking workflow) or may be replaced with the predefined user prompt. The determination (or decision) of which, if any, aspects of an LLM output to include in a user prompt may be used to tune the LLM that was used to generate the LLM output.

In some embodiments, operation 434 may include initiating a function call. An LLM may enable access to external application programming interfaces (APIs) by determining when and how a function should be called based on the context of an LLM prompt, and by structuring outputs based on a function specified in the LLM prompt. By way of non-limiting example, an LLM prompt may include a signature and a parameter of a weather function, and the LLM prompt may include a weather-related user input. The LLM may determine, based on the user input, a user intent to ask what the weather will be at a travel destination. In response to determining the user intent, the LLM may generate an output that includes an object (e.g., a JSON object) containing the weather function and arguments for calling the weather function. In some embodiments, operation 434 may include determining whether to call a function (e.g., a weather function) using function arguments provided by an LLM. In further aspects, operation 434 may include calling a function (e.g., a weather function) using function arguments provided by an LLM, and receiving returned data from the function. In some embodiments, operation 434 may include determining which, if any, aspect of returned data to provide to a user. By way of non-limiting example, operation 434 may include modifying the LLM output to include returned data or may include replacing the LLM output with returned data. In further aspects, determining to provide an aspect of the returned data to a user may include initiating a predefined travel planning workflow and may include populating the travel planning workflow with the returned data. The travel planning workflow may be provided to a user via a conversational UI. The travel planning workflow may replace the LLM output or may include an aspect of the LLM output. The determination (or decision) of which, if any, aspects of returned data to include in a user prompt may be used to tune the LLM that was used to generate the LLM output.

In some embodiments, a user prompt may be moderated to ensure a content, tone, structure, coherence, relevance, usefulness, appearance, or the like, of the user prompt is appropriate, is accurate, or abides by a guideline of a system (e.g., a system performing process 400). By way of non-limiting example, a content of a user prompt may be determined to be appropriate if the content includes no offensive language, such as profanity or threats, or no restricted words or phrases, such as names of competitor systems or competitor products. By way of non-limiting example, a content of a user prompt may be determined to be accurate if the content may be verified by fact-checking the content against information retrieved from a trusted source (e.g., a trusted internal or external database). A content of a user prompt may be determined to abide by a guideline of a system (e.g., a system performing process 400) if the content includes no personally identifiable information (PII). If an aspect of a user prompt (e.g., a content, a tone, a structure, a coherence, a relevance, a usefulness, an appearance, or the like) is determined to be inappropriate, to be inaccurate, or to violate a guideline of a system (e.g., a system performing process 400), then the user prompt may be rephrased to resolve the inappropriateness, the inaccuracy, or the violation, or the user prompt may be replaced with an alternative user prompt.

In some embodiments, a text-based user prompt may be transformed into a speech-based user prompt, the text-based user prompt having been determined or generated according to an LLM output. In some embodiments, a determined or generated user prompt may include at least one of text, voice, speech, audio, gesture, visual cue, and the like. In further aspects, an LLM output (e.g., a text-based LLM output) may be transformed to include at least one of text, voice, speech, audio, gesture, visual cue, and the like using AI techniques (e.g., multimodal models). A user prompt may be provided to a user via text (mode: text messaging), speech (mode: telephone call), or at least one of text and speech (mode: website or application).

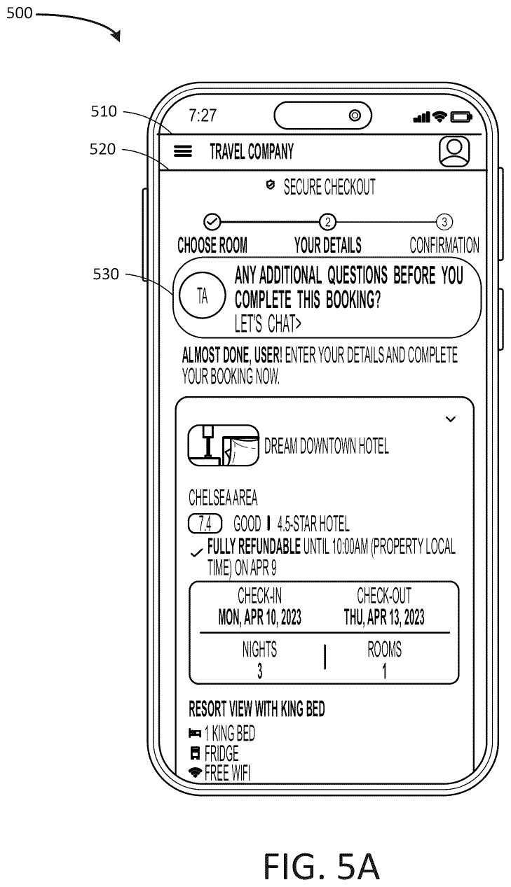

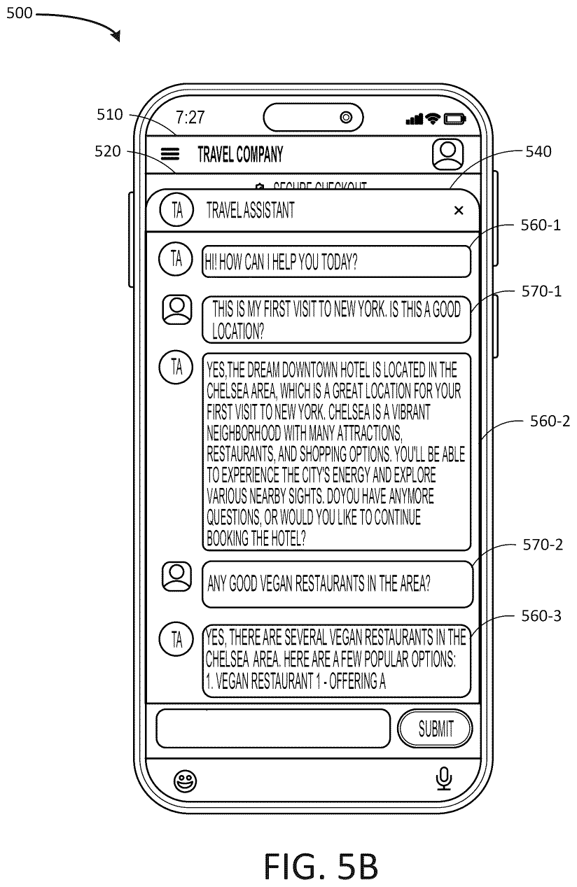

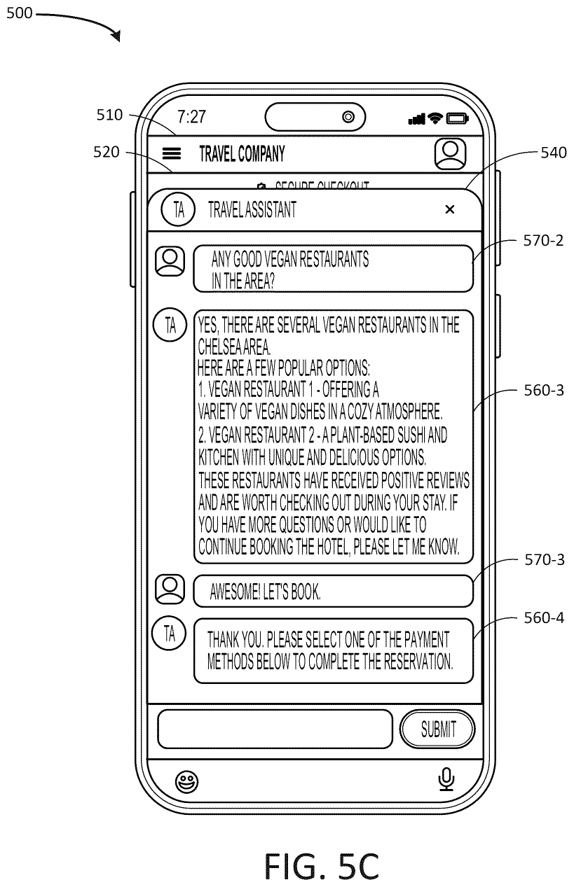

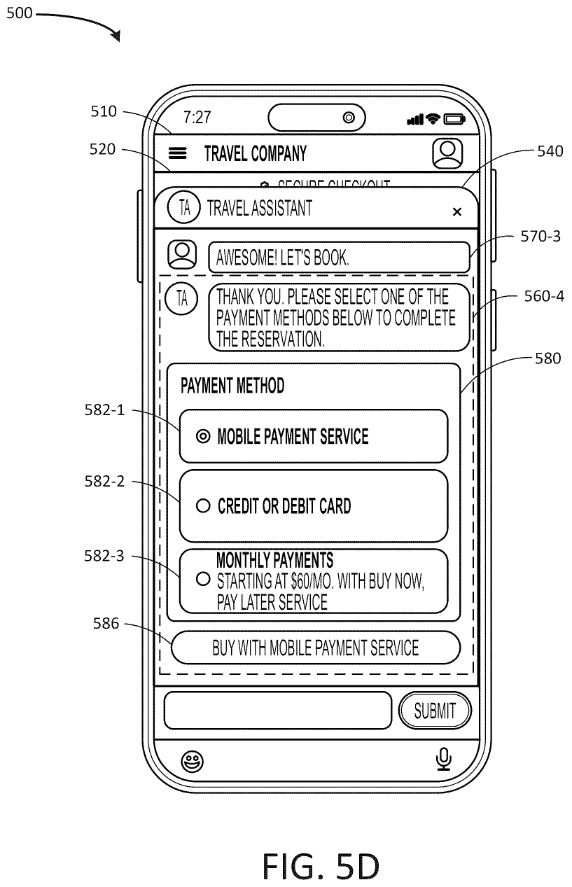

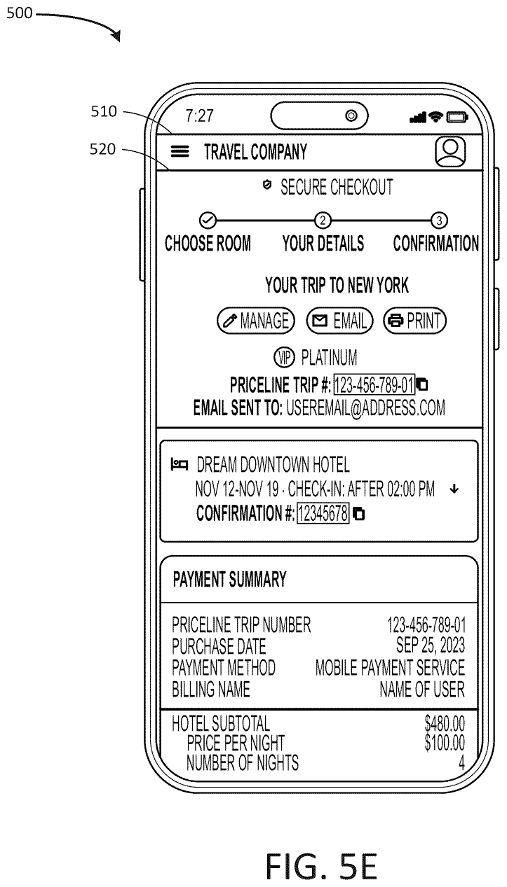

FIGS. 5A-5E illustrate an example view 500 of booking application 510 configured to include conversational user interface (UI) 540 for assisting a user with travel planning, according to some embodiments. Booking application 510 may be associated with a travel planning system (e.g., an online travel agent system). Conversational UI 540 includes a text-based conversational UI. In other embodiments, a conversational UI may include a text-based conversational UI of a text messaging service (e.g., a Short Message Service (SMS)), a speech-based conversational UI (e.g., of a telephone service, a website, or an application), or a text- and/or speech-based conversational UI (e.g., of a website or an application).

Booking application 510 includes checkout page 520. As shown in FIG. 5A, checkout page 520 includes travel assistant (TA) start button 530, which may be tapped, clicked, swiped, pressed, or otherwise selected to open or initiate conversational UI 540. Conversational UI 540 includes the following: user prompt 560-1, user prompt 560-2, user prompt 560-3, and user prompt 560-4 (hereinafter, collectively referred to as “user prompts 560”); user input 570-1, user input 570-2, and user input 570-3 (hereinafter, collectively referred to as “user inputs 570”). User prompt 560-4 includes payment workflow 580. Payment workflow 580 includes payment method button 582-1, payment method button 582-2, and payment method button 582-3 (hereinafter, collectively referred to as “payment method buttons 582”), and payment confirmation button 586.

As shown in FIG. 5B, user prompt 560-1 may be provided to a user, via conversational UI 540, soliciting from the user a query: “Hi! How can I help you today?” In some embodiments, an initial prompt composed for an ML model may include a hard-coded user input. The ML model may be instructed to output a hard-coded or a generated initial user prompt (e.g., user prompt 560-1) based on the hard-coded user input. In some embodiments, a hard-coded user input may be triggered when a user opens or initiates conversational UI 540 by tapping, clicking, swiping, pressing, or otherwise selecting TA start button 530. User input 570-1 may include a first query (e.g., about Dream Downtown Hotel in the Chelsea area of New York City, shown in checkout page 520): “This is my first visit to New York. Is this a good location?”

A product attribute (e.g., such as the name, location, star rating, or user rating of Dream Downtown Hotel, shown in checkout page 520) may be retrieved from a data source (e.g., checkout page 520). The product attribute may be associated with rules/guidelines based on the source of the product attribute data (e.g., checkout page 520). A rule/guideline may include a policy governing a required structure, format, or content of an output generated by an ML model. By way of non-limiting example, a structure may include one or more markers (e.g., keywords, phrases, sentiments, text strings, tags, flags, or the like) that the ML model should include in the output if the ML model determines a marker is associated with a user intent (e.g., a ready-to-book marker may be associated with a user intent to begin or to complete a booking of a room at Dream Downtown Hotel). By way of non-limiting example, a format may include a file format, such as JavaScript Object Notation (JSON), Extensible Markup Language (XML), or HyperText Markup Language (HTML). By way of non-limiting example, a content may include only information associated with booking application 510, and a content may exclude information associated with a competitor of booking application 510. A rule/guideline may be provided to an ML model in natural language, and the rule/guideline may be editable via a content management system (CMS) associated with booking application 510. In some embodiments, a rule/guideline may be automatically edited by a CMS. In some embodiments, a rule/guideline may be manually edited by a human administrator associated with booking application 510.

In some embodiments, user input 570-1 may be categorized by topic or subtopic according to a set taxonomy. For example, a user input 570-1 may be assigned main topic “hotel” and subtopic “neighborhood.” The categories may be added to user input 570-1 as metadata. In some embodiments, a sentiment analysis may be conducted on the user input to determine an emotional tone of the user input (e.g., a positive, negative, or neutral tone of the user input), and the sentiment may be added to user input 570-1 as metadata. In some embodiments, a flag (e.g., a yes-no flag) may be added to user input 570-1 as metadata. The flag may be used by an ML model to indicate whether a current user input addresses or answers the last user prompt.

Using user input 570-1 and an at least one product attribute, an ML model prompt (e.g., an LLM prompt) may be composed and may be provided to an ML model. In some embodiments, an ML model may be selected from a plurality of ML models based on at least one of user input 570-1 (e.g., based on a content, context, structure, or type of user input 570-1) and the at least one product attribute. By way of non-limiting example, an ML model may be selected based on the amount of data the ML model can process, or based on user input 570-1, including text input (cf., speech input).

Based on an ML output, user prompt 560-2 may be determined or generated: “Yes, the Dream Downtown Hotel is located in the Chelsea area, which is a great location for your first visit to New York . . . . Do you have any more questions, or would you like to continue booking the hotel?” User prompt 560-2 may include all aspects, no aspects, or some aspects of the ML model output. The ML model output may be processed to determine whether the ML model output includes a marker (e.g., keyword, phrase, sentiment, text string, flag, or the like), wherein the ML model may include the marker based on the ML model determining the marker is associated with a user intent. In example view 500, it may be determined that the ML model output does not include a marker. Based on determining the ML output does not include a marker, the user prompt may include hotel neighborhood information included in the ML output (e.g., “Chelsea is a vibrant neighborhood with many attractions”).

User input 570-2 may include a second query: “Any good vegan restaurants in the area?” According to processes and methods described herein, user prompt 560-3 may be determined or generated. As shown in FIG. 5C, user input 570-3 may include a third query “Awesome! Let's book.” According to processes and methods described herein, it may be determined that the ML model output generated in response to user input 570-3 includes a ready-to-pay marker. Based on determining the ML model output includes the ready-to-pay marker, user prompt 560-4 may be provided. User prompt 560-4 may include instruction information included in the ML model output (“Thank you. Please select one of the payment methods below to complete the reservation.”), and user prompt 560-4 may include payment workflow 580 (as shown in FIG. 5D). Conversational UI 540 may close automatically (e.g., in response to the submitting of a payment via payment workflow 580), or a user may manually close conversational UI 540 (e.g., by clicking an exit or a close button of conversational UI 540). As shown in FIG. 5E, in response to conversational UI 540 closing, automatically or manually, after the submitting of a payment, a booking confirmation including a payment summary may be displayed in checkout page 520.

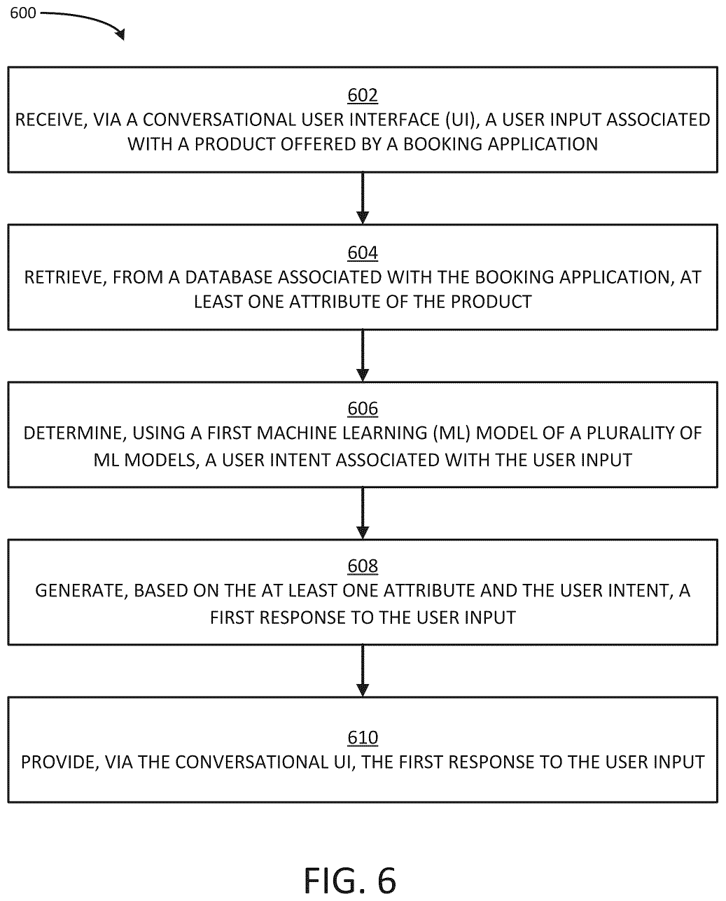

FIG. 6 is a flowchart illustrating operations in a method 600 for planning travel through an interactive conversational exchange, according to some embodiments. In some embodiments, processes as disclosed herein may include one or more operations in method 600 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 600 may be performed by an attribute retrieval module, a user intent determination module, a prompt composition module, or an output processing module (e.g., attribute retrieval module 232, user intent determination module 234, prompt composition module 236, or output processing module 238). In some embodiments, processes consistent with the present disclosure may include at least one or more operations as in method 600 performed in a different order, simultaneously, quasi-simultaneously, or overlapping in time.

Operation 602 may include receiving, via a conversational user interface (UI), a user input associated with a product offered by a booking application. In some embodiments, the user input may include a text input. In some embodiments, the product may include at least one of a lodging, a means of transportation, and a destination activity. In some embodiments, the booking application may include a travel booking application. In further aspects of the embodiments, operation 602 may include determining the user input includes personally identifiable information (PII). In further aspects of the embodiments, operation 602 may include redacting the PII from the user input.

Operation 604 may include retrieving, from a database associated with the booking application, at least one attribute of the product. In some embodiments, an attribute may include at least one of a cost attribute, such as a price or fee, a location attribute, such as an address or a proximity to a landmark, a facility attribute, such as a room type, an amenity attribute, such as a Wi-Fi availability, and a facility attribute, such as a room type. In some embodiments, an attribute may include at least one of a review, a rating, and a booking term or condition.

Operation 606 may include determining, using a first machine learning (ML) model of a plurality of ML models, a user intent associated with the user input. In some embodiments, the first ML model may include a large language model (LLM). In some embodiments, determining the user intent associated with the user input may include selecting the first ML model of the plurality of ML models based on the at least one attribute of the product. In further aspects of the embodiments, operation 606 may include determining the first response to the user input includes a marker indicating the user intent. In further aspects of the embodiments, operation 606 may include determining, based on the marker, a second response to the user input. In further aspects of the embodiments, operation 606 may include providing, via the conversational UI, the second response.

Operation 608 may include generating, based on the at least one attribute and the user intent, a first response to the user input. In some embodiments, generating the first response to the user input may include generating an instruction for a second ML model of the plurality of ML models, the instruction causing the second ML model to output the first response to the user input based on a policy governing a structure and a content of the first response, and the instruction causing the ML model to include, in the first response, metadata associated with the user input. In some embodiments, the second ML model may include a large language model (LLM). In some embodiments, the first and second ML models may be the same. In further aspects of the embodiments, operation 608 may include extracting the metadata from the first response. In further aspects of the embodiments, operation 608 may include storing the metadata in the database associated with the booking application.

Operation 610 may include providing, via the conversational UI, the first response to the user input. In further aspects of the embodiments, operation 610 may include initiating, via the conversational UI, a booking of the product, wherein the user intent includes an intent to book the product.

### Hardware Overview

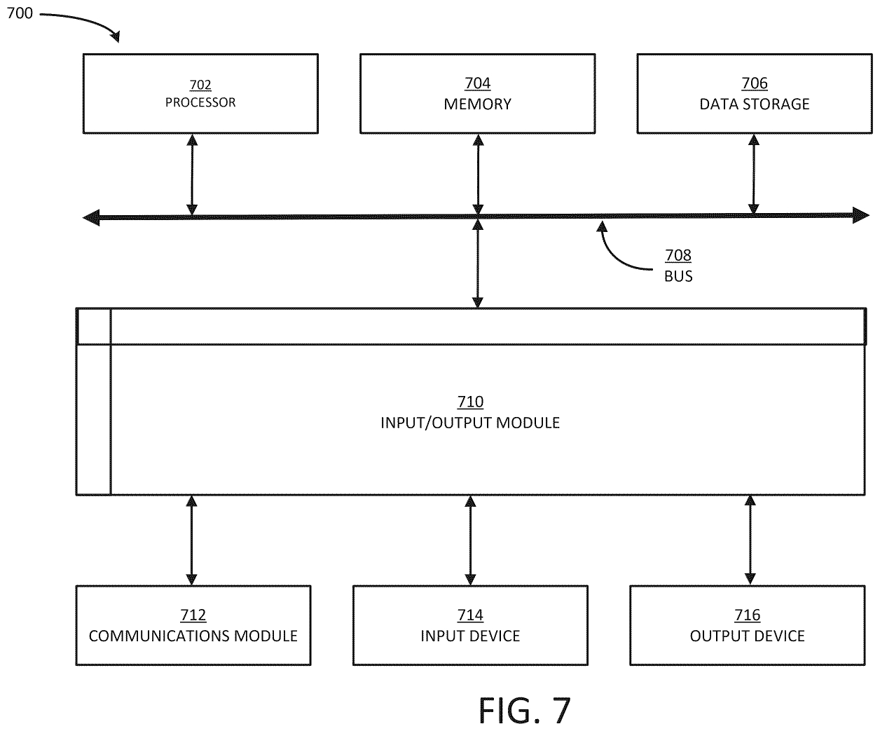

FIG. 7 is a block diagram illustrating an exemplary computer system with which client devices, and the methods and processes in FIGS. 3A-3B, 4A-4B, and 6 may be implemented, according to some embodiments. In certain aspects, the computer system 700 may be implemented using hardware or a combination of software and hardware, either in a dedicated server, or integrated into another entity, or distributed across multiple entities.

Computer system 700 (e.g., client device(s) 110 and server(s) 130) may include bus 708 or another communication mechanism for communicating information, and a processor 702 (e.g., processors 212) coupled with bus 708 for processing information. By way of example, computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 700 may include, in addition to hardware, code that creates an execution environment for the computer program in question, e.g., code that constitutes processor firmware, a protocol stack, a database management system, an operating system, or a combination of one or more of them stored in an included memory 704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. Processor 702 and the memory 704 may be supplemented by, or incorporated in, special purpose logic circuitry.

The instructions may be stored in memory 704 and implemented in one or more computer program products, e.g., one or more modules of computer program instructions encoded on a computer-readable medium for execution by, or to control the operation of, computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. Input/output module 710 may be any input/output module. Exemplary input/output modules 710 include data ports such as Universal Serial Bus (USB) ports. The input/output module 710 may be configured to connect to a communications module 712. Exemplary communications modules 712 (e.g., communications modules 218) include networking interface cards, such as Ethernet cards and modems. In certain aspects, input/output module 710 may be configured to connect to a plurality of devices, such as an input device 714 (e.g., input device 214) and/or an output device 716 (e.g., output device 216). Exemplary input devices 714 include a keyboard and a pointing device, e.g., a mouse or a trackball, by which a user may provide input to computer system 700. Other kinds of input devices 714 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 716 include display devices, such as an LCD (liquid crystal display) monitor, for displaying information to the user.

According to one aspect of the present disclosure, client device(s) 110 and server(s) 130 may be implemented using computer system 700 in response to processor 702 executing one or more sequences of one or more instructions contained in memory 704. Such instructions may be read into memory 704 from another machine-readable medium, such as data storage device 706. Execution of the sequences of instructions contained in memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 700 may include clients and servers. A client and server may be generally remote from each other and typically interact through a communication network. The relationship of client and server arises by virtue of computer programs running on the respective computers and having a client-server relationship to each other. Computer system 700 may be, for example, and without limitation, a desktop computer, laptop computer, or tablet computer. Computer system 700 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

1. A computer-implemented method for travel planning, comprising:
receiving, via a conversational user interface (UI), a user input associated with a product offered by a booking application;
retrieving, from a database associated with the booking application, at least one attribute of the product;
determining, using one or more machine learning (ML) models of a plurality of ML models, a user intent associated with the user input, wherein the one or more ML models are dynamically selected from the plurality of ML models based on an availability of resources of the one or more ML models;
generating, based on the at least one attribute and the user intent, a first response to the user input; and
providing, via the conversational UI, the first response to the user input.

2. The computer-implemented method of claim 1, wherein:
the product includes at least one of a lodging, a means of transportation, and a destination activity; and
the booking application includes a travel booking application.

3. The computer-implemented method of claim 1, wherein:
the user input includes a text input; and
the one or more ML models includes one or more large language models (LLMs).

4. The computer-implemented method of claim 1, further including:
determining the user input includes personally identifiable information (PII); and
redacting the PII from the user input.

5. The computer-implemented method of claim 1, wherein determining the user intent associated with the user input includes:
selecting the one or more ML models of the plurality of ML models based on the at least one attribute of the product.

6. The computer-implemented method of claim 1, wherein generating the first response to the user input includes:
generating an instruction for the one or more ML models of the plurality of ML models, the instruction causing the one or more models to output the first response to the user input based on a policy governing a structure and a content of the first response, and the instruction causing the one or more ML models to include, in the first response, metadata associated with the user input.

7. The computer-implemented method of claim 6, wherein:
the one or more ML models include one or more large language models (LLMs).

8. The computer-implemented method of claim 6, wherein providing the first response to the user input includes:
extracting the metadata from the first response; and
storing the metadata in the database associated with the booking application.

9. The computer-implemented method of claim 1, further including:
determining the first response to the user input includes a marker indicating the user intent;
determining, based on the marker, a second response to the user input; and
providing, via the conversational UI, the second response.

10. The computer-implemented method of claim 1, further including:
initiating, via the conversational UI, a booking of the product, wherein the user intent includes an intent to book the product.

11. A system, comprising:
one or more processors; and
a memory storing instructions that, when executed by the one or more processors, cause the system to perform operations including:
receiving, via a conversational user interface (UI), a user input associated with a product offered by a booking application;
retrieving, from a database associated with the booking application, at least one attribute of the product;
determining, using one or more machine learning (ML) models of a plurality of ML models, a user intent associated with the user input, wherein the one or more ML models are dynamically selected from the plurality of ML models based on an availability of resources of the one or more ML models;
generating, based on the at least one attribute and the user intent, a first response to the user input; and
providing, via the conversational UI, the first response to the user input.

12. The system of claim 11, wherein:
the user input includes a text input;
the product includes at least one of a lodging, a means of transportation, and a destination activity;
the booking application includes a travel booking application; and
the one or more ML models include one or more large language model (LLMs).

13. The system of claim 11, wherein the operations further include:
determining the user input includes personally identifiable information (PII); and
redacting the PII from the user input.

14. The system of claim 11, wherein determining the user intent associated with the user input includes:
selecting the one or more ML models of the plurality of ML models based on the at least one attribute of the product.

15. The system of claim 11, wherein generating the first response to the user input includes:
generating an instruction for one or more ML models of the plurality of ML models, the instruction causing the one or more ML models to output the first response to the user input based on a policy governing a structure and a content of the first response, and the instruction causing the ML model to include, in the first response, metadata associated with the user input.

16. The system of claim 15, wherein:
the one or more ML models include one or more large language models (LLMs).

17. The system of claim 15, wherein providing the first response to the user input includes:
extracting the metadata from the first response; and
storing the metadata in the database associated with the booking application.

18. The system of claim 11, wherein the operations further include:
determining the first response to the user input includes a marker indicating the user intent;
determining, based on the marker, a second response to the user input; and
providing, via the conversational UI, the second response.

19. The system of claim 11, wherein the operations further include:
initiating, via the conversational UI, a booking of the product, wherein the user intent includes an intent to book the product.

20. A non-transitory computer-readable storage medium storing instructions encoded thereon that, when executed by a processor, cause the processor to perform operations comprising:
receiving, via a conversational user interface (UI), a user input associated with a product offered by a booking application, wherein
the user input includes a text input,
the product includes at least one of a lodging, a means of transportation, and a destination activity, and
the booking application includes a travel booking application;
retrieving, from a database associated with the booking application, at least one attribute of the product;
selecting one or more machine learning (ML) models of a plurality of ML models based on the at least one attribute of the product and based on an availability of resources of the one or more ML models, wherein the one or more ML models include one or more large language models (LLMs);
determining, using the first one or more ML models, a user intent associated with the user input;
generating, based on the at least one attribute and the user intent, a first response to the user input;
determining the first response to the user input includes a marker indicating the user intent;
determining, based on the marker, a second response to the user input;
providing, via the conversational UI, the second response; and
initiating, via the conversational UI, a booking of the product, wherein the user intent includes an intent to book the product.
